(19) United States
(12) Patent Application Publication
(10) Pub. No.: US 2013/0290127 A1
(43) Pub. Date: Oct. 31, 2013

(54) System and Method for Enabling Sales Requests and Offers from Multiple Buyers in Online Environment

(71) Applicant: James Finseth, Hermosa Beach, CA (US)

(72) Inventor: James Finseth, Hermosa Beach, CA (US)

(21) Appl. No.: 13/347,655

(22) Filed: Jan. 10, 2012

Related U.S. Application Data
(60) Provisional application No. 61/431,381, filed on Jan. 10, 2011.
(60) Provisional application No. 61/451,606, filed on Mar. 11, 2011.

(51) Int. Cl. G06Q 30/06

(52) U.S. Cl. CPC G06Q 30/0611
USPC 705/26.4

(57) ABSTRACT

Methods and systems for selling and purchasing items in an online environment, including a set price purchase process and a negotiated price/value purchase process. The system presents to a potential buyer one or more specific product(s) which is/are available for immediate purchase at a pre-set price; provides the potential buyer with the option to request sellers to offer product(s) at a lower price (which may be set forth by the potential buyer), and/or offer the product(s) with different options, and/or to offer similar product(s); and provides sellers with the opportunity to offer the product and/or options to the potential buyer at the requested price/with the requested option, and/or to make offers to the potential buyer to provide the product(s) at different price(s) and/or with different options and/or to provide a different but similar product.

### RELATED APPLICATIONS

The present application claims priority under 35 U.S.C. §119(e) to U.S. Provisional Application No. 61/431,381, filed on Jan. 10, 2011 and entitled “System and Method for Enabling Sales Requests and Offers in Online Environment”, and to U.S. Provisional Application No. 61/451,606, filed on Mar. 11, 2011 and entitled “System and Method for Enabling Sales Requests and Offers from Multiple Buyers in Online Environment”, the entire contents of each of which are hereby incorporated herein by reference.

### FIELD OF THE INVENTION

The present invention relates to the field of electronic commerce, and more particularly to a network-based system and method for presenting request(s) from a potential buyer to multiple sellers, and receiving responsive offers from one or more sellers, concerning the sale of goods/services in an electronic commerce transaction.

### BACKGROUND OF THE INVENTION

The internet provides consumers and sellers the opportunity to shop for and purchase goods/services online, and also provides sellers with the ability to market and offer their goods/services online. Numerous comparison shopping sites are currently in operation via the internet. These sites permit a consumer to review information regarding products (e.g., price, features, delivery options, etc.), and to purchase such products at the price shown. Some sites provide auctions which permit the consumer to bid on purchases of such products, with the winning bidder contractually obliged to complete the transaction if he/she submits the winning bid.

The available shopping sites tend to concentrate on the price of the product, and generally do not provide the flexibility for a consumer to find the best overall value by requesting different prices, product features, etc., from multiple sellers. The available shopping sites generally do not provide the sellers with the opportunity to “bid” for the potential buyers' business, or to offer the consumer the option to purchase different but similar products. While existing web sites can provide some ability for buyers and sellers to negotiate deals (typically via a bidding process), the options for such negotiations are generally limited to variations in price in a bidding environment, and the bidding process of a specific auction is generally restricted to one specific product from a specific seller. Other options, such as quantity discounts, free shipping, substitution of similar products, etc., are generally not a part of a bid system.

An effective electronic commerce system for satisfying needs of a potential purchaser with offers/counters from multiple sellers is desired, which provides flexibility for the purchaser and sellers to negotiate and conclude sales.

### SUMMARY OF THE INVENTION

Briefly stated, the present invention overcomes the problems identified above by providing a system and method that permits potential buyers to negotiate with multiple sellers for the best values. The invention permits potential buyers to make requests (e.g., a request for a specific product with specific options at a specific price, etc.), and for multiple sellers to submit offers/counters to a potential buyer's request. A seller can make an offer which matches the buyer's request, or can make a counter which is different from the buyer's request.

A system according to the invention may provide potential buyers with the opportunity to browse and/or search for products, via a host system, and instantly purchase such products directly from listed sellers. The buyers will also have the opportunity to negotiate with sellers, in a fashion similar to a reverse auction, using a process conducted via the host system. The negotiation process of the host system permits a potential buyer to request specific prices (or price ranges) and/or value-added perks (such as free shipping, gift wrapping, quantity discounts, etc.) and/or similar products (e.g. different brands, different colors, etc.).

A system according to the invention permits sellers to receive free leads (in the form of buyer requests) on potential sales. Such leads can be provided to sellers who have listed products for sale which match or are close to that requested by the potential buyer, and/or to sellers who have expressed an interest in receiving requests for products such as those set forth in the particular request. The system thus provides sellers, even those who have not listed any specific products for sale, with the opportunity to receive requests from potential buyers and to submit offers/counters to such requests.

The system provides the opportunity for buyers and sellers to negotiate sales based not merely on price but on overall value. The system provides flexibility for buyers and sellers to propose different products, options, prices, etc.

A host system according to the invention may include a product database, hosted by the host system, of products available for sale by listed sellers. As a supplement to or in lieu of a host system product database, the host system may receive information regarding products being offered for sale from various sellers via one or more outside product databases, such as product database(s) provided by one or more 3^{rd} parties. For example, based on a search or request by a potential buyer, the host system may initiate a search of one or more outside databases of products offered for sale by various sellers. The results of such a search may be presented to the potential buyer as the potential buyer browses the web page(s) of the host system.

The host system of the invention receives requests made by potential buyers, assesses/categorizes the requests, and matches each request with one or more specifically identified sellers who may be interested in providing an offer to sell products responsive to the offer. The host system then sends a communication (e.g., via email) to the identified sellers, with the communication including the details of the request from the potential buyer. The identified sellers can then submit (to the host system) offers/counters to the potential buyer's request. These offers/counters are then transmitted from the host system (via, e.g., email) to the potential buyer. The system could require the seller or sellers to offer deep discounts (e.g., discounts of at least a certain percent less than their regular price) and/or free shipping and/or other perks as a requirement to have the seller's offers/counters forwarded to potential buyers.

The system of the present invention is configured to receive from a potential buyer a request for a product or products, which may include specifically desired/acceptable options such as the desired brand, model, size, color, pre-assembled, used/demo models, etc. as well as a desired price (which may include shipping costs, etc.). The product(s) may be goods and/or services. The request may also indicate options and aspects about which the potential buyer is willing to compromise. For example, the potential buyer may indicate a range of sizes, or may indicate multiple models, manufacturers, etc. in which the buyer is interested.

The host system compares the request with the offered goods/services of sellers in the host system database, and identifies specific sellers which are considered likely to have goods/services which match (either exactly or closely) the buyer's request. In one embodiment, each seller will have indicated the (broad or narrow) category of products, or specific products, etc., for which it would like to receive requests. For example, a seller could indicate that it wants to receive all requests concerning electronics. The seller could further limit its requests to those concerning televisions, and/or could further limit its request to LCD televisions which are between 40 and 60 inches diagonal dimension. Moreover, the host system may provide the seller the option to modify the seller database information for the particular seller in order to broaden or limit the requests received by the seller.

In one embodiment, the host system forwards the buyer's request to all sellers which are listed in the specific category selected by the buyer. In another embodiment, the host system selects only a limited number of sellers to receive the request. The selection of sellers may be determined by a random sampling of the sellers from the seller database who have indicated a desire to receive buyer requests pertaining to that particular category of products. In another embodiment, the host system compares the additional language of the request (i.e., more than just the category) to attempt to match the most relevant sellers. The host system may attempt to match the category and/or other language of the request with the category/other language of specific sellers, and/or may use the buyer's IP address to select sellers that are most likely to be in the buyer's physical area. The host system may identify sellers which have previously sold product to the particular buyer.

Once the relevant sellers are identified, the host system then transmits the buyer's request (e.g., via email) to the specifically identified sellers. In an embodiment of the invention, the seller's can also consult the requests directly by signing into the host system and viewing the particular seller's information page. The sellers are then provided with the opportunity to make an offer which matches the potential buyer's request, or to make counters which are different from the specifics of the request in price, product, options, etc., or to reject the request.

When a seller receives an email or other communication about a request, or if the seller wishes to check for any pending requests, the seller can log into a seller's page on the host system. Once logged in, e.g., using a seller-specific username and/or password, the seller can see lists of all pending requests it has received. In an embodiment of the invention, listed with each request are 3 options, which can be in the form of web links. The options may be as follows: (1) accept the request as is (i.e., offer the product at the requested price and with the requested options); (2) accept the request with changes (e.g., offer the product at a different price, offer the product with different option(s), and/or offer a different but similar product, etc.); and (3) reject the request. The seller may also simply ignore the request.

One aspect of a host system is revenue generation. In one embodiment, when a potential buyer browses and/or searches for a product via the host system server and also clicks on a product search result, the host may receive a share of the so-called cost-per-click (CPC) revenue. In an embodiment of the invention, the host receives a payment (e.g., a percent commission of the sale) when a successful sale occurs via the host system. For example, when a buyer submits a request, a negotiation process (i.e., request/offer/counter/etc.) is begun between the potential buyer and responding sellers. Upon conclusion of the negotiations with a successful sale, the host will receive payment for the commission, or the host can credit itself for such payment to occur at a future scheduled date from the Seller. In one embodiment of the invention, the sales commission is drawn upon a credit card and/or bank information of the seller, with the credit card/bank information having been provided by the seller in advance as a precondition for the seller registering with the host and receiving the request(s) from the buyer(s). In a further embodiment of the invention, the sales commission is provided to the host directly from the payment received from the buyer.

Further revenue generation may be provided by charging so-called “pay to play” fees to buyers and/or sellers. For example, a buyer may be charged a fee for submitting a request for offers. Such fees may be charged on a “per request” basis. A seller may be charged a fee for submitting offers/counters. Such fees may be charged on a “per offer” basis.

In an embodiment of the invention, potential buyers have the opportunity to combine efforts to obtain reduced prices by purchasing multiple items together. An originating buyer dynamically generates a group deal with such an embodiment. For example, the originating buyer can solicit other potential buyers to join in the initial request, and/or to join in accepting resulting offers from sellers, thus building purchasing coalitions to purchase in volume at corresponding discounts. The invention thus provides buyers with the opportunity to create their own group deals, with sellers competing with each other for the business of a potential group of buyers.

Embodiments of the invention thus are methods and systems for selling and purchasing items in an online environment, including a set price purchase process and a negotiated price/value purchase process. The system presents to a potential buyer one or more specific product(s) which is/are available for immediate purchase at a pre-set price. The system also provides the potential buyer with the option to request sellers to offer product(s) at a lower price (which may be set forth by the potential buyer), and/or offer the product(s) with different options, and/or to offer similar product(s). The system provides one or more sellers with the opportunity to offer the product and/or options to the potential buyer at the requested price/with the requested option, and/or to make one or more offers to the potential buyer to provide the product(s) at different price(s) and/or with different options and/or to provide a different but similar product. The potential buyer can review all product offers from the multiple sellers and accept the offer which appears most attractive. The potential buyer may enter additional requests responsive to the seller's/sellers' offers. Further requests/offers/counters may be made by either party until agreement is reached and a sale is made, or until the parties end negotiations without concluding a sale. The further requests/offers/counters may include a different price (or range of prices) and/or different options and/or different but similar products.

These and other aspects of the invention, together with the benefits and advantages realized, will become apparent from a reading of the following detailed description in conjunction with the drawings.

### BRIEF DESCRIPTION OF THE DRAWINGS

FIG. 1 is a block diagram representing a system for conducting electronic commerce according an embodiment of the invention;

FIG. 2 is a logical flow diagram generally illustrating a process performed by an implementation of the present invention for conducting electronic commerce according to an embodiment of the invention;

FIG. 3 is a logical flow diagram generally illustrating a process performed by a further implementation of the present invention for conducting electronic commerce according to an embodiment of the invention;

FIG. 4 is a sample screen display of a home page display when interfacing with an implementation of the invention;

FIGS. 5-7 are sample screen displays that may be presented to a potential buyer when interfacing with one implementation of the invention;

FIGS. 8-15 are sample screen displays that may be presented to a seller when interfacing with one implementation of the invention; and

FIG. 16 is a logical flow diagram generally illustrating a process performed by a further implementation of the present invention for conducting electronic commerce according to an embodiment of the invention.

### DETAILED DESCRIPTION OF PREFERRED EMBODIMENTS

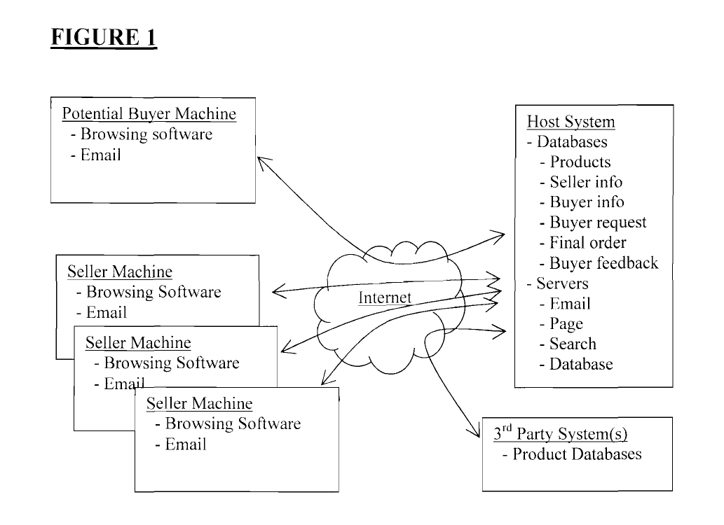

FIG. 1 depicts a block diagram illustrating components of a network-based system according to an embodiment of the invention. The elements includes user-side components in the form of one or more potential buyer input/output device(s) (such as a buyer's computer/machine/other device with respective programs to interact with the internet and the other components of the system, with input via keyboard/keypad/touchscreen/microphone, and output via screen, speaker, etc.), and multiple sellers' input/output device(s) (such as a seller's computer/machine/other device with respective programs to interact with the internet and the other components of the system), with input via keyboard/keypad/touchscreen/microphone, and output via screen, speaker, etc.).

The user-side components are connected to the main host-side system via a communications network such as the internet. The host-side system may include multiple databases, such as a database of products being offered for sale, a database of sellers offering products for sale, and also of sellers who may be interested in offering products responsive to requests from potential buyers, etc. The host-side system may further include multiple servers, including electronic communication servers (e.g., email servers for sending emails to buyers and sellers), page servers, search servers, database servers, etc., as well as multiple databases, such as seller information databases, buyer information database, buyer request database, final order database, buyer feedback/comments database, etc.

The system may include the ability to consult additional product databases, such as product databases run by 3^{rd} parties, in order to provide information to the potential buyer about additional products. The host system may interact with such 3^{rd} party databases with application programming interfaces (APIs), which permit the host system to smoothly interact with the 3^{rd} party databases.

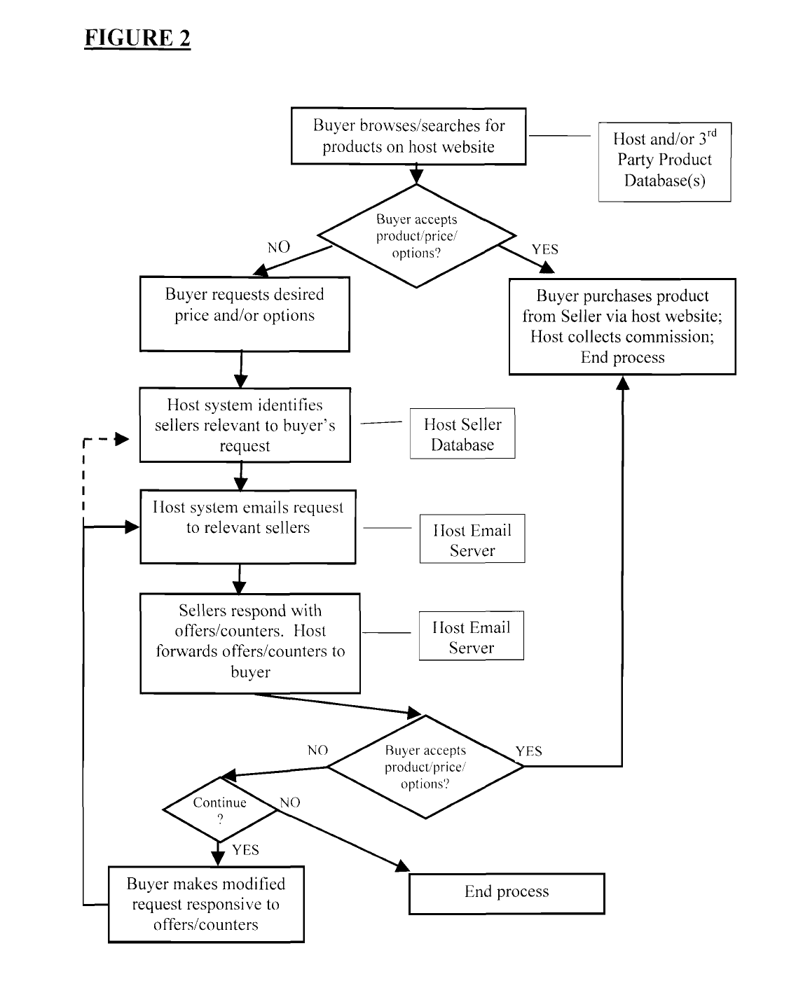

FIG. 2 depicts a flow chart of a method according to an embodiment of the invention. A potential buyer can access the host website/system, e.g., from the buyer's computer via the internet as was depicted in FIG. 1. The host system uses its own, and/or 3^{rd} party, product databases to provide the user with product listings/information (including corresponding seller pricing for the product) in a browsing and/or search mode from the host website.

If the potential buyer finds a product offered by a seller with desired options and an acceptable price, the potential buyer can click on a link on the website to indicate the buyer's acceptance of the seller's advertised price, product, and features. The buyer may then be linked to a seller-specific webpage (which may be hosted by the host system) to complete the purchase of the product. When the potential buyer completes the purchase, a commission is collected from the seller.

If the potential buyer is not satisfied with the product prices/features/options listed as available for instant purchase, the buyer may submit a request for offers via the host system. The request may include aspects of the product (e.g., type of product, manufacturer, size, color, etc.), a desired price, shipping details, etc.

Using information from its seller database, the host system will identify which sellers are relevant to the buyer's request. The host system will then send communications (e.g., emails via the host email server) to the identified sellers, which may include details of the buyer's request and/or information on how to retrieve those details via the internet.

The sellers who receive the request will have the opportunity to submit an offer or offers (via the host system, e.g., via the host email server) matching the request, and/or to make counters (i.e., offers which do not exactly match the request). The host will forward (e.g., via email), or otherwise make available, such offers/counters to the potential buyer.

If the potential buyer is satisfied with the details of a matching offer and/or counter, the buyer can indicate via the host system its acceptance of the offer/counter. The potential buyer will then be linked to the seller-specific webpage of the host system in order to complete the purchase. The host will then be paid its commission, and the process may be concluded.

If the potential buyer is not satisfied with the details of any particular matching offer, the buyer can choose to end the process. The buyer can also choose to continue, and can then submit an additional request, which may be modified from the initial request (e.g., in response to offers/counter from the sellers). The additional request(s) will be transmitted by the host system (e.g., via email server) to identified sellers (which may be the same sellers as received the initial request, or may be newly-identified as relevant based on the parameters of the new request). The process of requests/offers/counteroffers can continue until a sale is made or the buyer decides to end the process by not making further requests.

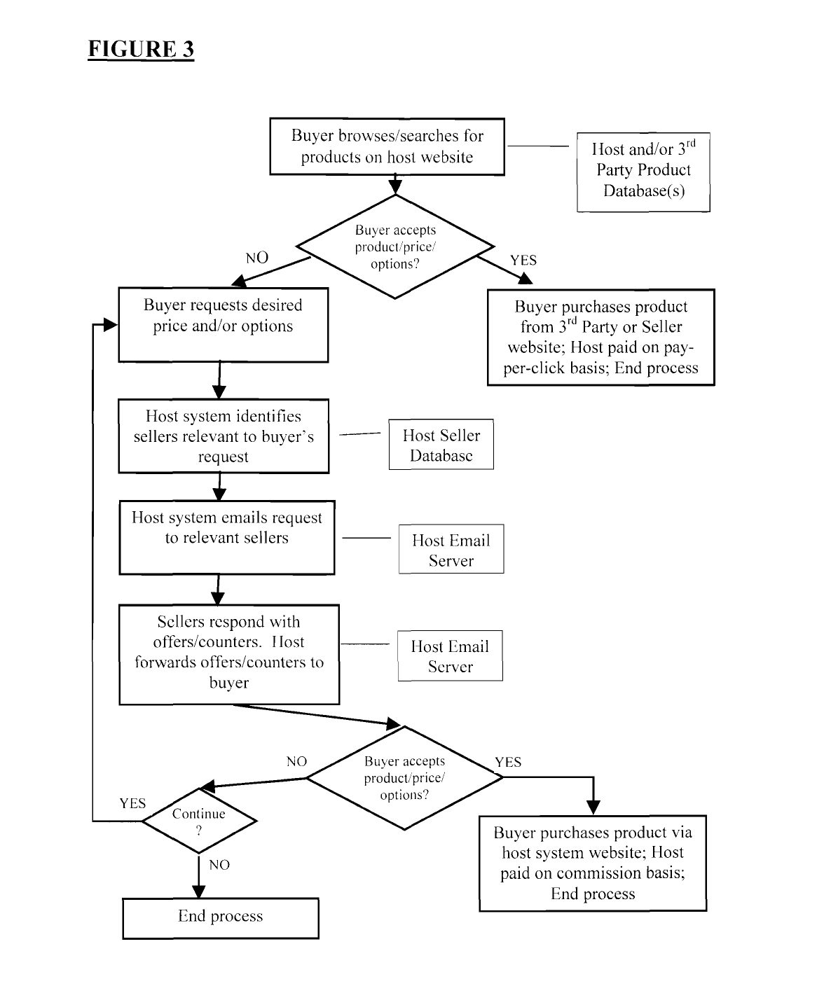

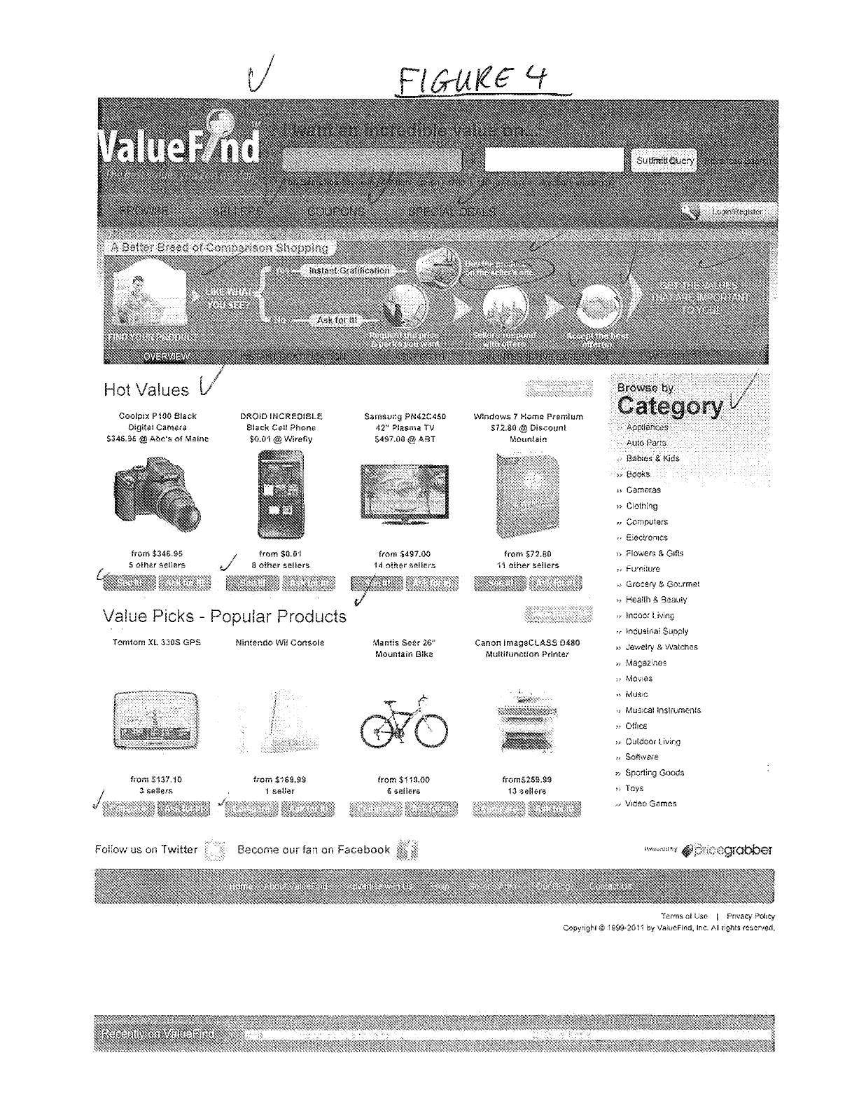

FIG. 3 depicts a flow chart of a method according to a further embodiment of the invention. A potential buyer can access the host website/system, e.g., from the buyer's computer via the internet as was depicted in FIG. 1. The host system uses its own, and/or 3^{rd} party, product databases to provide the user with product listings/information (including corresponding seller pricing for the product) in a browsing and/or search mode from the host website. If the potential buyer finds a product offered by a seller with desired options and an acceptable price, the potential buyer can click on a link on the website to indicate the buyer's acceptance of the seller's advertised price, product, and features. The buyer may then be linked to a 3^{rd}-party or seller-specific webpage, outside of the host system, to complete the purchase of the product. The host is compensated on a pay-per-click basis.

If the buyer is not satisfied with the product prices and options listed in its initial search, the buyer can submit a request for offers at lower prices, with different options, etc. The system selects the sellers to receive the request, and forwards the request to those sellers. The sellers can then submit offers/counters to be forwarded to the buyer. If the buyer finds an offer/counter to be acceptable, the buyer can click to accept it and be forwarded to a purchase webpage of the host system to complete the purchase. When the purchase is completed, the host system will receive payment (or credit for payment) of a sales commission based on a percentage of the purchase price. The commission may be collected from the seller via a credit card on file for the specific seller in a host system database.

Revenue generation may be provided by charging so-called “pay to play” fees to buyers and/or sellers. For example, a buyer may be charged a fee for submitting a request for offers, and/or a seller may be charged a fee for submitting offers/counters. The seller(s) and/or buyer(s) “pay to play” fees may be reduced and/or refunded in total if a sale is actually completed based on the request and/or offer for which the fee was paid.

In the methods of the invention, identifying which sellers are to receive a buyer's request may be performed using one or more steps. For example, all sellers which have selected, as part of the seller's profile in the host system database, the particular broad category of products of the request may receive that request. The sellers may be randomly selected. The sellers receiving the request may be limited in total number—for example, the host system may send a particular request to only 25 sellers. The host system could use one or more words or other parameters from the request to attempt to identify relevant sellers to receive the request. The host system could attempt to send the request to sellers who are geographically closer to the buyer, such as by using the buyer's IP address to determine the most likely area in which the buyer is located. The host system could also select sellers to receive the request from a list of sellers with whom the buyer has had contact previously, such as by looking at the buyer's history to see which seller's the buyer has purchased from, and/or sent requests to, and/or received offers/counters from. The host system could also send requests to sellers who have paid a premium to receive additional/extensive/particular requests.

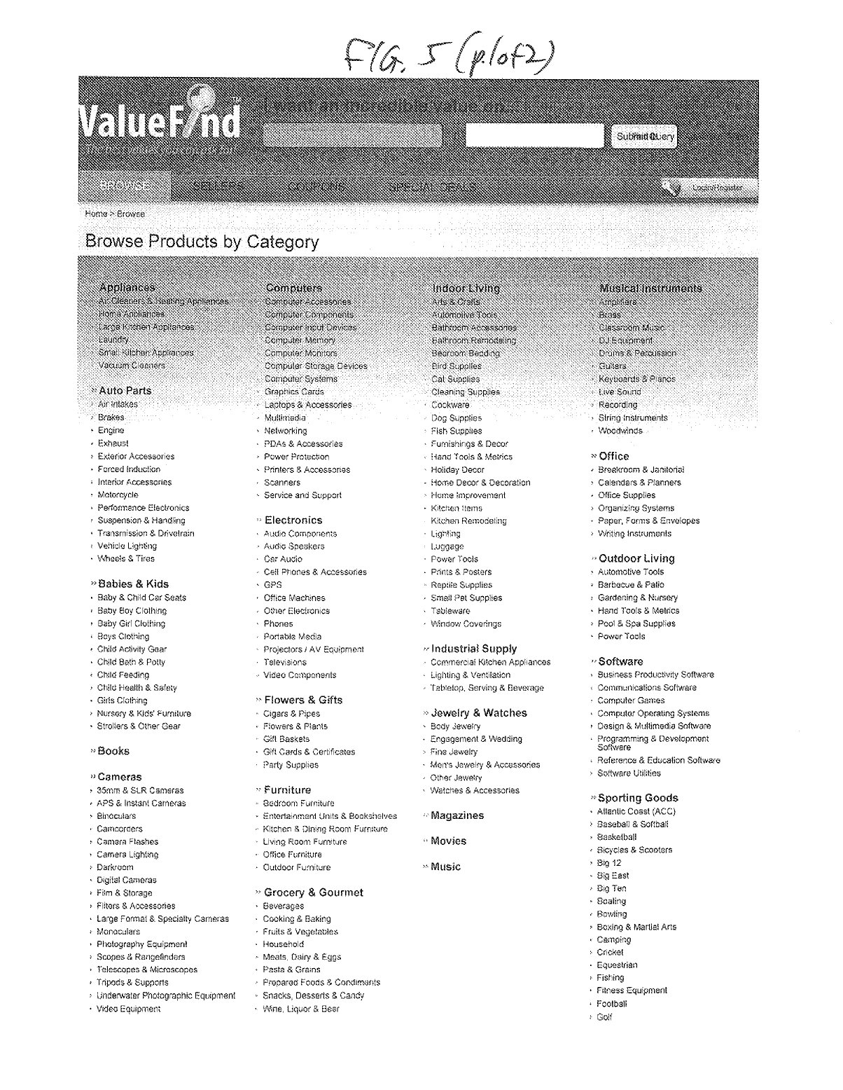

FIG. 4 is an example of a page, such as a home page, of a host system according to an embodiment of the invention.

FIG. 4 depicts an embodiment of a page, such as home page, which may be provided by the host system to users via an internet or similar connection. The opening screen is provided responsive to a user inputting a specific web address into his/her computer, and/or clicking (via the mouse or similar input device on his/her computer) on a link to that specific web address.

The host home page may include a list of so-called “hot values,” which are specific items offered by a specific merchant at a specific price. To list a product as a “hot value,” the seller may pay a fee to the host system. The host home page may also include a list of so-called “value picks,” which are particularly popular products, typically available from multiple sellers. The potential buyer can click on a “compare” button with each value pick product, and the host system will display on the buyer's computer a list of sellers who are offering the particular product, as well as the prices each seller is listing for the product.

The home page or other page provided by the host system may provide an identifying reference corresponding to the web site, e.g., a brand name and/or website domain name, e.g., brandname.com.

A page provided by the host system, such as the home page of FIG. 4, may provide an overview (via direct display and/or link), which may comprise a visual diagram and/or descriptive text, of the process/options by which a user (buyer or seller) may use the system to make purchases and/or requests/offers/counters. For example, the visual diagram may provide a flow diagram of the options (and corresponding steps) the potential buyer has for purchasing products or making requests/counters to sellers.

The host system may be configured to provide coupons to the potential buyer, with the coupons providing discounts for one or more products offered for sale by one or more sellers. In an embodiment of the invention, the home page or other page provided by the host system may include a link which, when activated by a potential buyer, opens a web page providing a list of available coupons and corresponding links thereto. When a potential buyer activates a specific coupon link, the potential buyer is given the option to use the coupon in a purchase transaction via the system. The coupons may provide reduced prices, discounts, and the like for purchase made via the system. The coupons may be received from 3^{rd} party websites which provide coupons in an online environment, with the host system receiving pay-per-click revenue when the coupon is clocked on via the host system.

The coupons may be received from specific manufacturers and/or specific sellers. Sellers or outside manufacturers may have the opportunity to list their coupons on the system by merely requesting such listings or by paying a fee to the host. The sellers may pay to list their coupons on the coupon page, or such listings may be provided free to sellers, or to sellers who complete specific steps or achievement (e.g., registering as preferred sellers, exceeding a minimum number of sales in volume or price, etc.).

In addition to, or in lieu of, the coupons, the host system may be configured to provide offers of special deals to potential buyers. Such specials may only be available for a limited time, such as so-called “daily specials” which are only available on a specific day. In an embodiment of the invention, the home page may include a link which, when activated by a potential buyer via the buyer's computer, opens a web page providing a list of available special deals and corresponding links thereto. Special deals may include reduced pricing, free shipping, and other options.

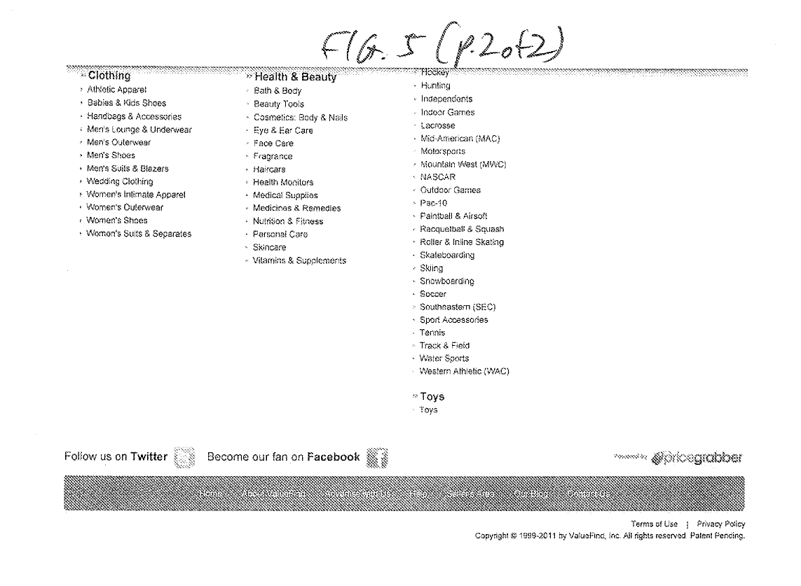

A page provided by the host system, such as the home page of FIG. 4, may provide the potential buyer with the opportunity to search for specific products via search terms selected and input by the potential buyer. A page may also, or alternatively, provide the potential buyer with the opportunity to browse for specific sellers by selecting one or more product categories and/or subcategories, and/or to brows through lists and/or icons/thumbnails of products available from preferred sellers, with the browsing conducted via listed categories/subcategories, such as “appliances” or “computers,” etc. A sample list of categories and subcategories is depicted in FIG. 5, entitled “browse seller by category.”

The host system may provide lists and/or icons/thumbnails of the most popular products, which may be arranged by category. The host page(s) may include lists (e.g., icons/thumbnails) of so-called “hot values,” which are specific items offered by a specific merchant at a specific price. To list a product as a “hot value,” the seller may pay a fee to the host system. The host home page may also include a list of so-called “value picks,” which are particularly popular products, typically available from multiple sellers. The potential buyer can click on a “compare” button with each value pick product, and the host system will display on the buyer's computer a list of sellers who are offering the particular product, as well as the prices each seller is listing for the product. The lists/icons may include links to further information regarding the specific product listed, and/or to comparisons of the specific product against other products.

To initiate a search, the potential buyer may input search terms (e.g., “LCD television”) and select a category (e.g., “electronics”). The potential buyer may also be able to conduct a so-called “advanced search,” which may be provided on the same web page or on a separate web page (e.g., via a further link as shown in FIG. 4). The advanced search may provide the potential buyer with the ability to search for products via IPC barcode, ISBN, manufacture part number (PN), and/or other identification numbers or search parameters.

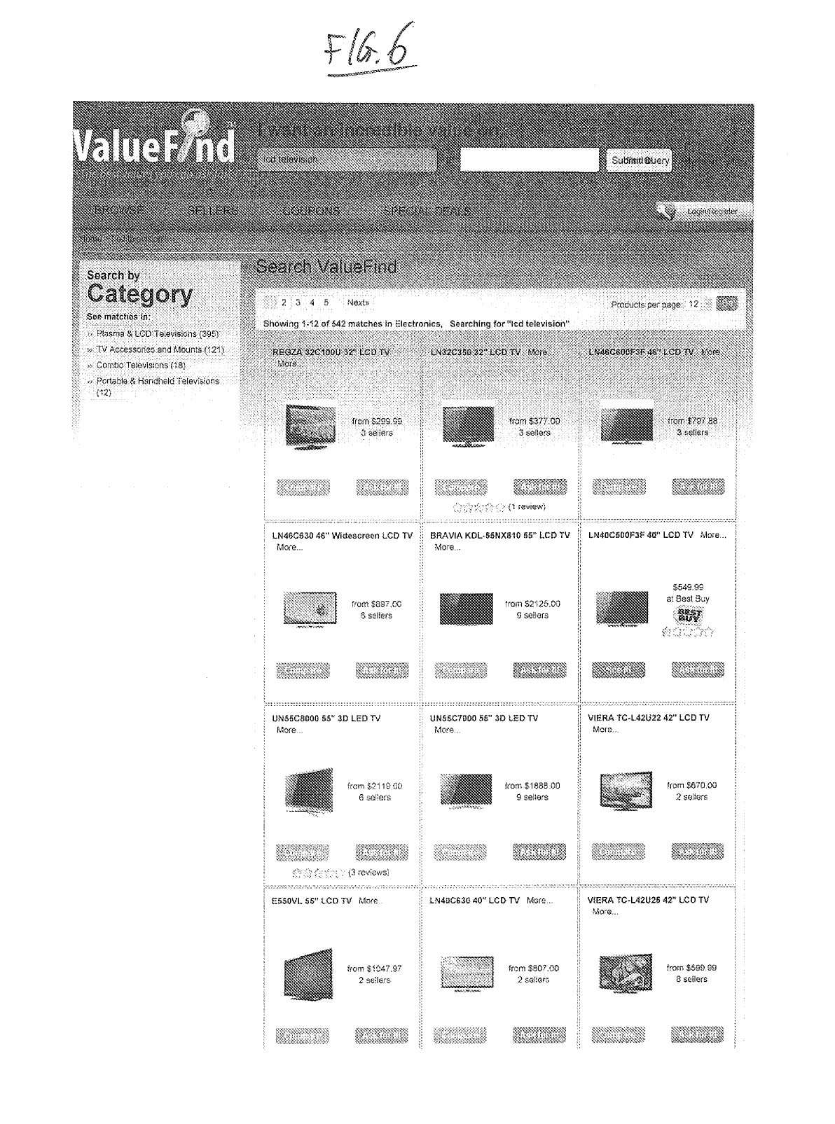

By entering search terms and clicking on a search link (such as the “find it” link on the home page depicted in FIG. 4), the host system will consult product databases and provide appropriate search results, which may be provided in a format such as that depicted in FIG. 6. The identified products are listed with lowest price or price range, and the number of sellers offering the product. With one or more identified product listings is provided a “compare” link and a Request link (depicted as “ask for it” in FIG. 4). When a user activates the Compare link, the host system provides (e.g., via a pop-up or new web page) a listing of sellers offering the product as well as the corresponding “set” purchase prices from each seller.

In one embodiment, the host system sets forth a set purchase price for a specific product, with the set purchase price provided by the seller via the seller's computer and the network connection. The set purchase price may represent a binding offer from the seller to sell the particular product at that price. A potential buyer may review the product information and the set purchase price, and if the set purchase price and/or product and/or other options offered by the seller are agreeable the buyer may indicate his/her acceptance of the offer to sell the product for the set purchase price. The host system may then forward the buyer to a secure web site, such as 3^{rd} party sales web site or a web site of the host system. The secure web site may be specific to the particular seller. At the secure web site, the buyer may conclude the purchase by selecting and entering information such as payment options (e.g., credit card), shipment options (e.g., shipping address, shipping methods), etc.

As depicted in FIG. 6, one or more identified product listings in the search results may include a Request link (depicted as “ask for it” in FIG. 6). In an embodiment, the host system provides a potential buyer (via the Request link) with the option to submit to the host system a request for a specific deal, which may include a specific purchase price (or price range) for a product and/or other product options (e.g., different color product) and/or other purchase benefits (e.g., free shipping, gift wrapping, volume discount, etc.). In an embodiment of the invention, the potential buyer's request is not a binding offer to purchase from a specific seller, and is instead a broad request for proposals/offers from multiple sellers.

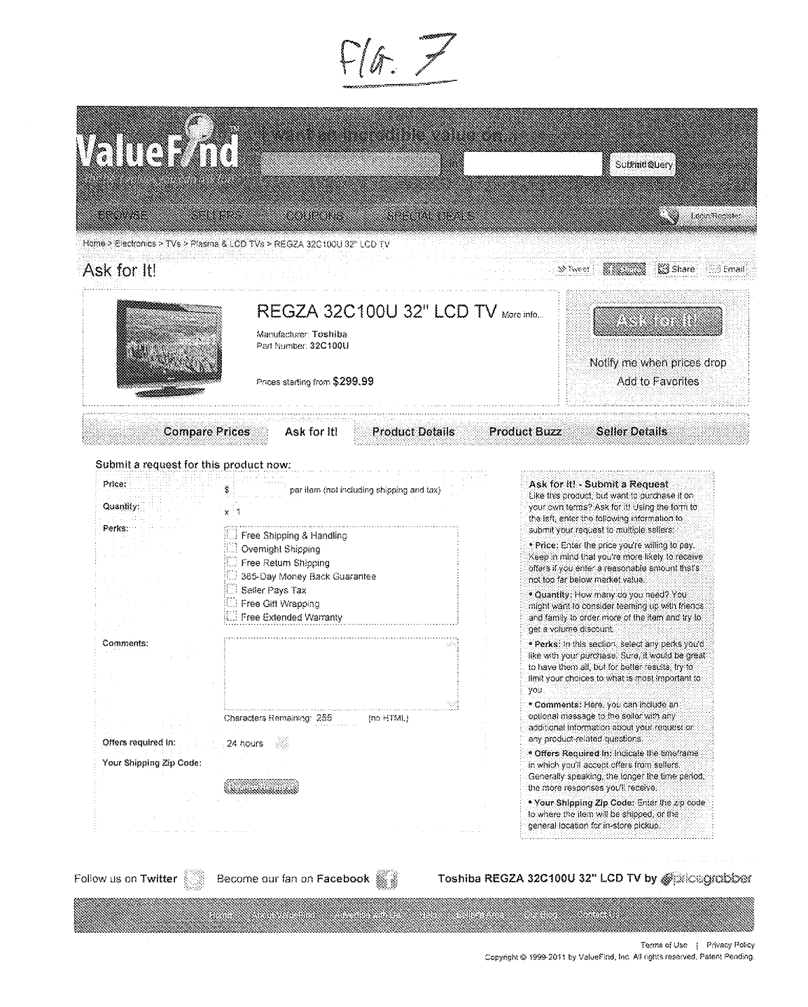

If the potential buyer activates the Request link, the host system will provide a web page/popup display such as that depicted in FIG. 7, in which the potential Buyer can input the details of its request. For example, the potential Buyer may request a specific product at a specific price, in specific quantity, with specific Perks (e.g., free shipping), and also include additional comments (such as “also interested in different products having similar features”).

The Request page, such as that depicted in FIG. 7, may include additional links, such as links to Compare Prices (listing the prices at which different sellers are offering the product), Product Details (with details of the product, such as weight, dimension, etc.), Product Reviews/Buzz, and/or Seller Details (providing a list of sellers offering the product). The page may also include a link that the potential buyer can activate to be added to a list for email receipt from the host system if the listed prices on the product drop, as listed in the product database(s).

When the potential buyer's request is submitted to the host system, the host system provides that request, via email (via host email server) or similar methods/devices, to sellers who are listed in the host system seller database as being interested in providing the specific products requested and/or products similar to those requested. The sellers receiving such emails of the buyer's request may ignore the request, offer the product at the requested price and with the requested options, or make a counter to the request. The potential buyer's request may have a deadline by which any responses from sellers must be received by the host system. Sellers may indicate their offer to match the details of the potential buyer's request, or make counteroffers, via the host system, with the host system providing such acceptances/counteroffers to the buyer via email or similar communication.

The host system may provide (e.g., via a page server) a seller-specific page or pages through which sellers can access the host system. A seller sign-in page may permit a seller to sign in to a secure portion of the host system, via a seller-specific username and/or password. The host system may include a seller registration page (or the registration may be provided as an input and/or link from the seller sign-in page), through which a seller can register with the host system. Seller registration may be free, or may require the seller to pay a fee. Seller registration may require that the seller provide a deposit and/or bank account information and/or credit card information. In an embodiment of the invention, seller registration and/or listing an item for sale requires no up-front fees, but instead the seller will pay a fee to the host only if an actual sale is concluded. The fee may be applied from the deposit and/or bank account and/or credit card of the seller.

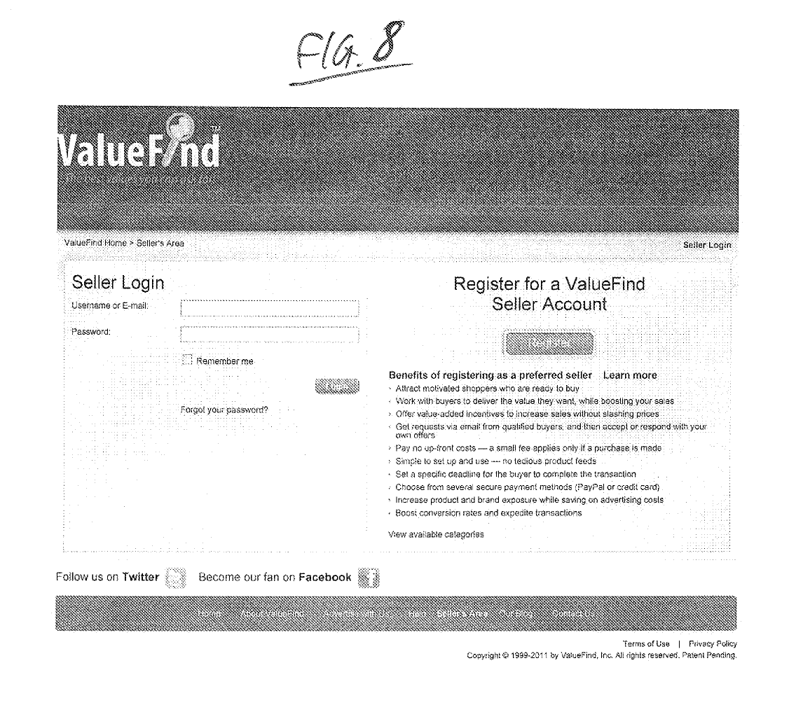

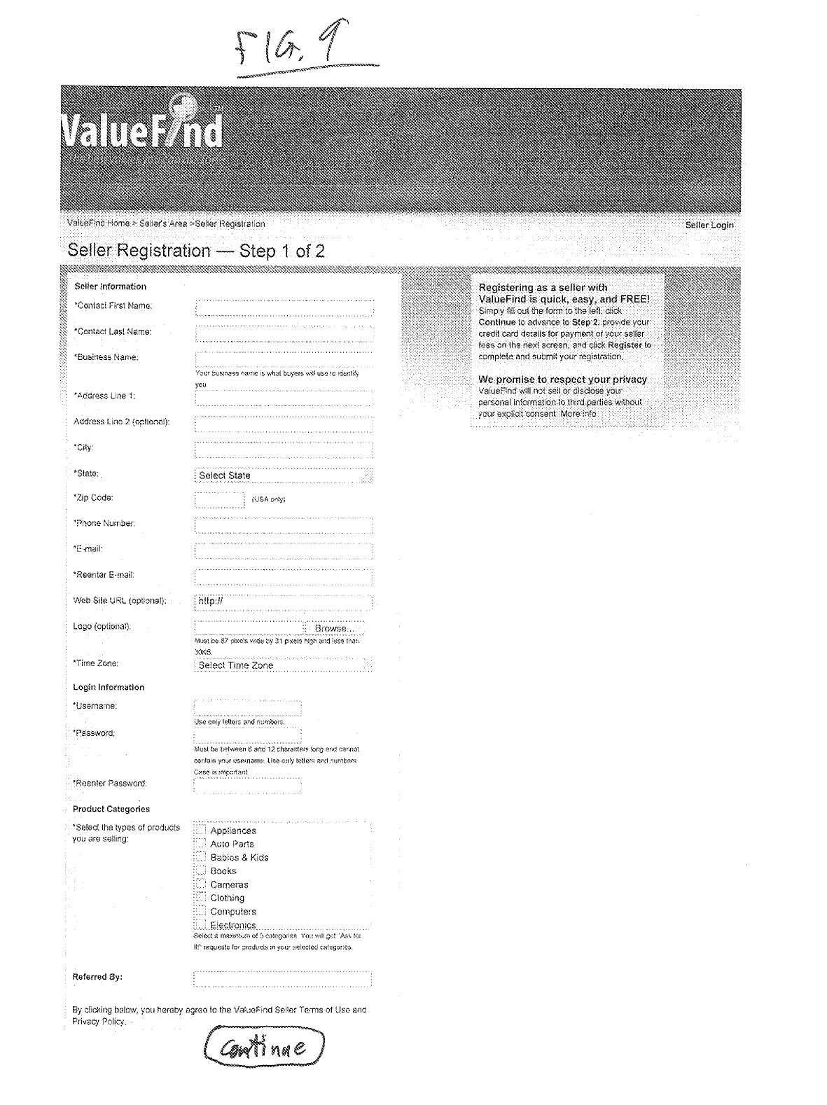

In the home page of FIG. 4, there is link at the bottom for use by sellers. When the link is activated, the host system provides the seller's computer with a log-in page display, which may provide a display such as the one depicted in FIG. 8. On that page, already-registered seller's can sign in to their accounts by providing identifying information such as user name and password. New sellers can register by clicking on the registration link, which will open a new web page such as that depicted in FIG. 9 (which in the sample depicted is entitled “Seller Registration—Step 1 of 2”) in which a new seller can enter relevant information, such as seller business name; seller contact info (private) such as first name, last name, etc; address; phone/fax; email address; web page URL; logo (which can be an image, such as PDF or JPG); time zone; and also seller-specific sign-in information such as a username and password. The new seller can also select the categories for which it would like to receive requests, and also indicate who referred the new seller to the host system. Once this information is entered, the new seller is forward to a new webpage in which the new seller can input its credit card (or other secure payment) information. The seller can then submit the credit card information and be registered, at least on a preliminary basis.

Note that the system may include a further step of seller authorization/screening before the seller registration is finalized. In an embodiment of the invention, prospective sellers are reviewed before their registration is accepted (i.e., before they are able to list items on the host page and/or make offers responsive to buyer requests). In such a review, the prospective seller's business information may be reviewed for accuracy; credit reports may be assessed; and other information may be reviewed/considered, such as membership in organizations such as the Better Business Bureau, online credentials, merchant verification, etc.

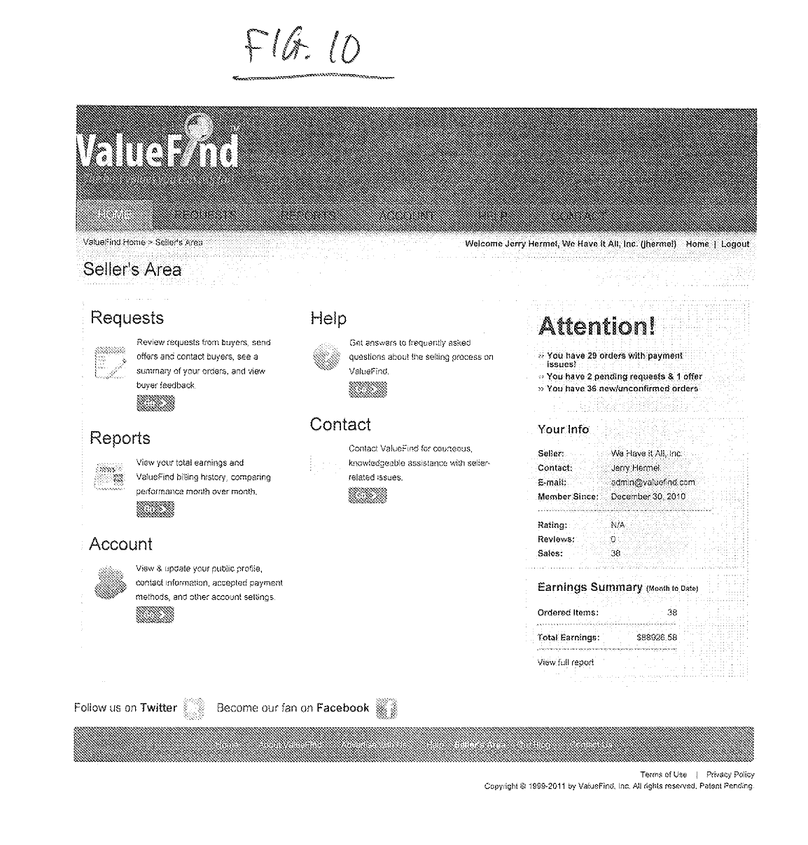

Once a seller is registered, the seller can sign in to the system (e.g., using username and password), which will take the seller to a web page such as that depicted in FIG. 10, which in the embodiment depicted is entitled “Seller's Area”. That page provides links which the seller can select to view Requests, to see Reports (of the seller's past sales/offers/counters/etc.), for Help, for Contact (contact info of the host), and to see the seller's Account information (some of which the seller can edit, such as address, desired categories, etc.).

If the seller activates the Help link, it will be taken to a web page listing frequent questions and corresponding answers. If the seller activates the Contact link, it will be taken to a web page providing the ability to input a question/request and other contact information (name, email, URL, etc.) and to have that question/request forwarded (via, e.g., email) to the host.

If the seller activated the “Reports” link, it will be taken to a web page providing reports of the seller's activities with the host system. Such reports may include billing history reports and earnings history reports, and may include commission fees paid to the host.

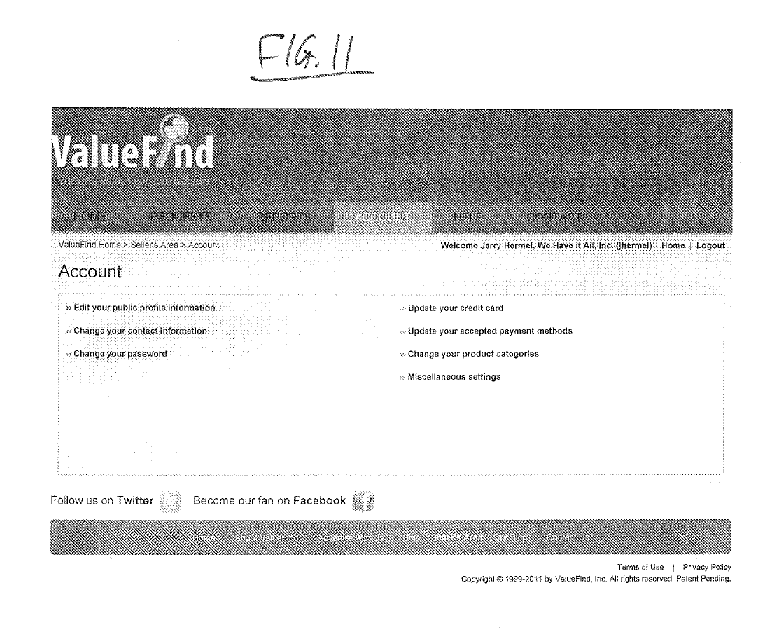

If the seller activates the Account link, it will be taken to a web page such as that depicted in FIG. 11, at which the seller can input/edit/change account information such as public profile information, contact information, password, credit card info, accepted payment methods info, product categories, and other settings. The seller's information is stored in a seller database of the host system.

There are many examples of the type of information that may be stored within a seller database according to an embodiment of the invention. The information, all or some of which may be encrypted, may include: the seller's host system sign-in information such as a user name, seller ID, password (which may be encrypted); the seller's private contact information, such as first name, last name, business name, private address (street/city/state/zip/country), private phone, private fax, private cell, private email address; the seller's public information (to be listed publicly on the host system pages fur review by buyers, etc.), such as public address/phone/fax/email, general description of business, shipping policy, return policy, link to seller's web site, and a copy of the seller's logo; and/or other seller-specific information such as the seller's time zone, a list of the categories for which the seller has elected to receive related requests, the maximum number of categories which the particular seller is permitted to select, and a minimum price percentage threshold. The minimum price percentage threshold is used to limit the requests provided to a seller to those which the seller is most likely to be interested. For example, the seller may select a minimum price percentage of 60%, which means that the host system will only forward requests to the seller that are requesting a product price that is at least 60% of the minimum listed “immediately available” price for that product.

Regarding the limitations on product categories for sellers, some sellers may be limited to a specific number, such as 5 categories, while other sellers may have higher (or no) limits based on their sales volume, product range, payment of a fee to the host, etc.

The seller database may also include the seller's credit card information, payment methods accepted by the seller (e.g., PayPal, specific credit cards, merchant account, etc.), status/history of seller activity (e.g., requests accepted with as is offer, requests accepted with modified offer, requests rejected, requests received, etc.), average offer price, total sales, buyer feedback ratings (e.g., on scale of 1-5), number of reviews for each rating, commission percent charged by host system for that seller (which could vary for particular sellers), first sign-up day, and the host system sales person who signed the seller up.

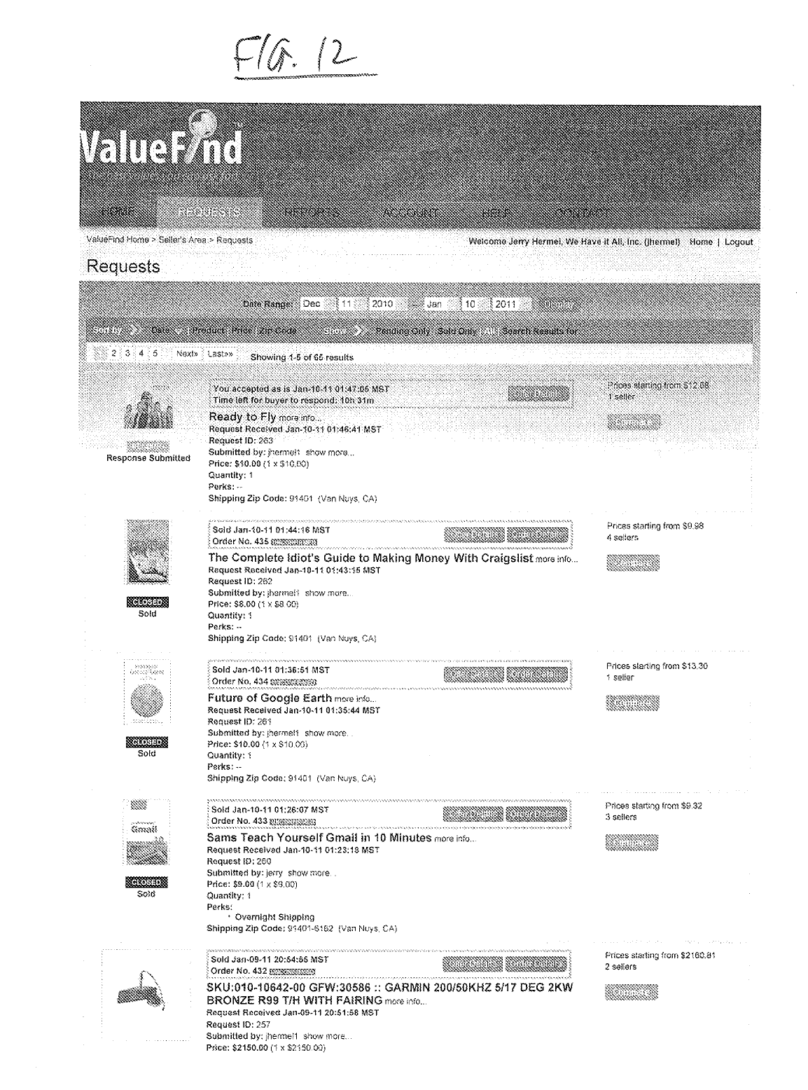

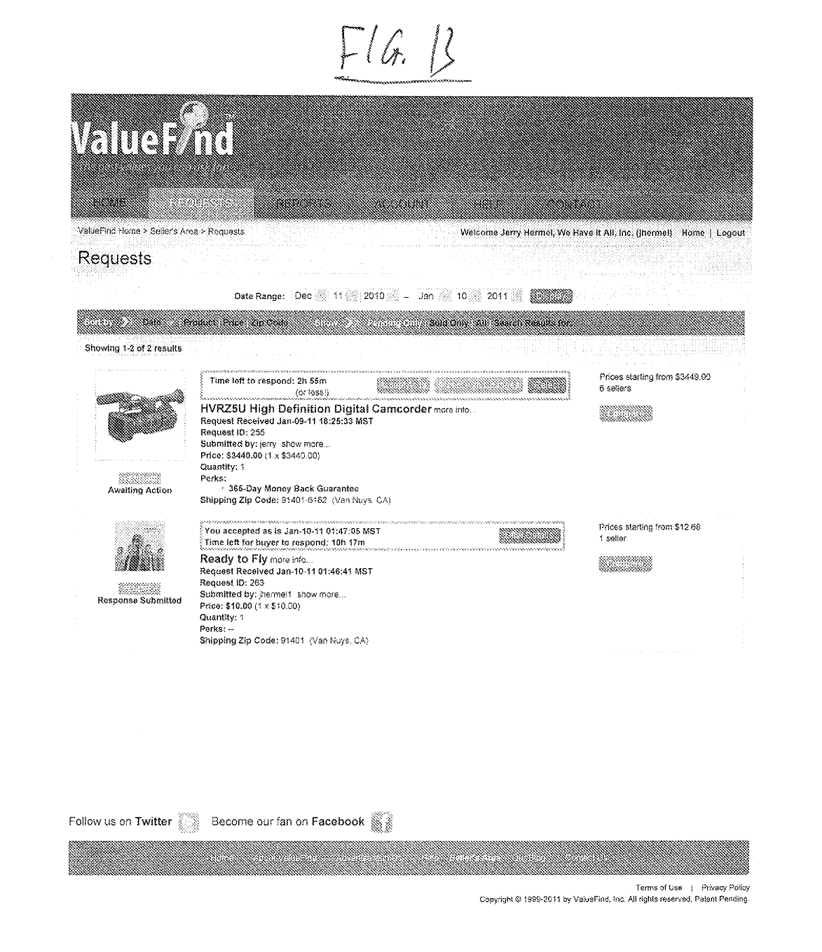

By clicking on a “Requests” link such as depicted in the page of FIG. 8, the host system will provide the seller's computer with a web page, such as those depicted in FIGS. 12 and 13, showing Buyer Requests which the particular seller has received. The page lists the status, and corresponding dates, of these request. Status indicators may include wording such as: “you accepted as is [date]” (i.e., request accepted as is, offer made); “you accepted with modifications [date]” (i.e., you made counter); “you rejected [date]”; “sold [date]”; “buyer purchased product from another seller [date]”; “buyer declined [date]”; and “you let expire [date]” (i.e., request was ignored). Each request may include a link to show details of the offer, request, and/or order. The request may include a link to “compare” the product, which may lead to a web page listing the prices at which the product is offered by various sellers.

As depicted in FIG. 13, where a Request is pending, the seller can select to “accept as is”, “accept with changes”, and “reject.” The seller can also simply ignore the request by taking no action.

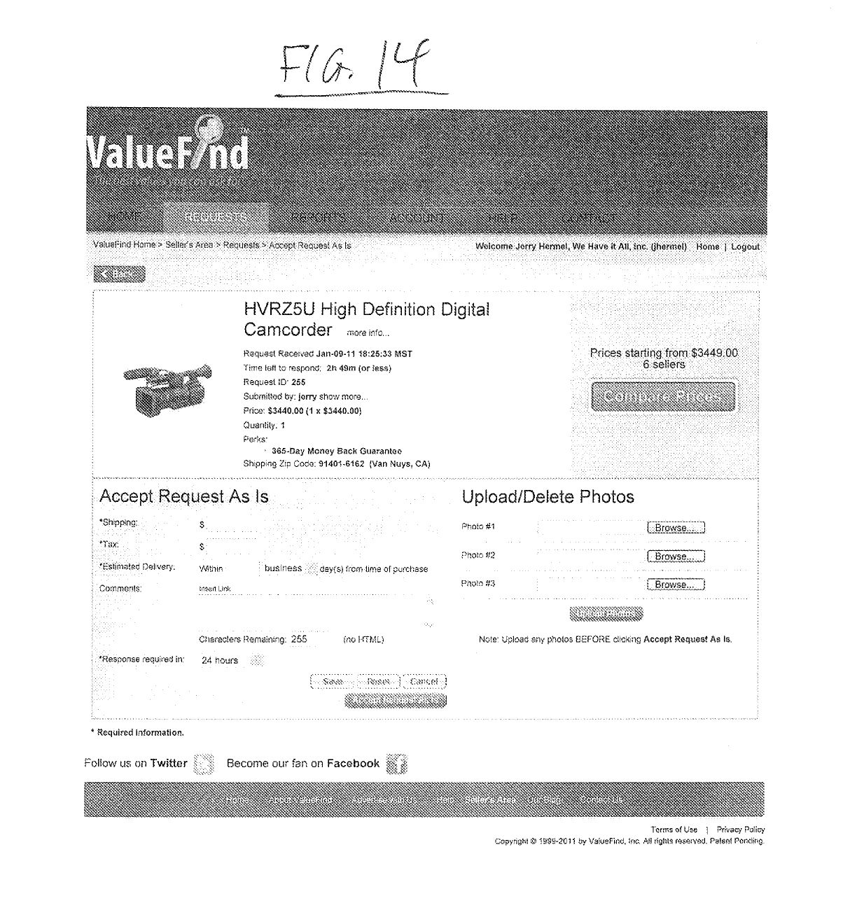

One option is to “accept as is”, which is to say that the seller offers the product at the requested price and with the requested options of the potential buyer. If the seller wants to accept the buyer's request without changes, the seller clicks on the “accept as is” link and is taken to new web page, such as that depicted in FIG. 14, where the buyer can enter information such as shipping details/shipping price (if not specified by the buyer in the request), tax (if not specified in the buyer's request), estimated delivery in days (calendar or business) from the date of purchase, additional seller's comments (entered via a text box), response required by (i.e., deadline for potential Buyer to accept Seller's offer), and option for Seller to upload photos/images of the product.

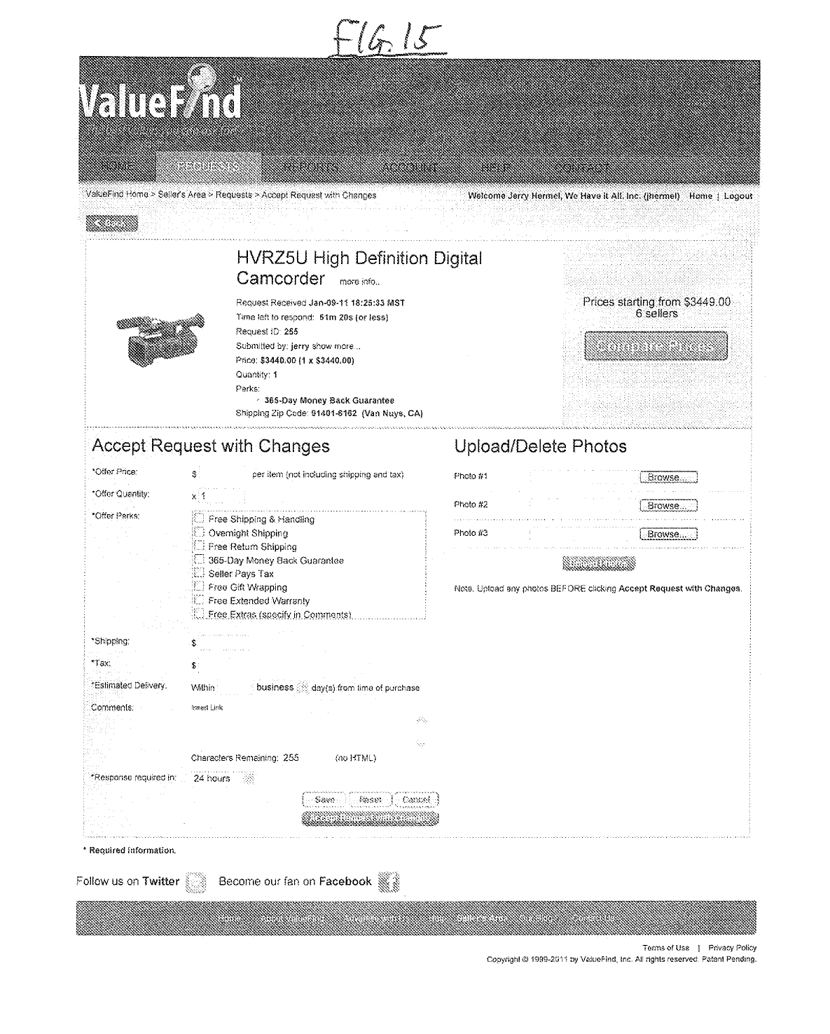

Another option is for the seller to present an offer in for the form of a counter, i.e., to “accept with changes.” This option is similar to the “accept as is,” but when this link is activated the seller is taken to a web page such as depicted in FIG. 15 which includes more options than presented in FIG. 14. The seller will have the option to present an offer different from the request, such as a different price, different quantity, different options/perks, etc. The seller can also specify information such as shipping details/price, tax, estimated delivery days from date of purchase, additional comments, response required by date, and optional upload of product images/photos. A seller may even counter with a similar price (or an identical price), but for a product which is different. For example, if a potential buyer requests a specific price for a specific television including express shipping, one or more sellers could counter with a different price and/or different television (television of similar capabilities but from a different manufacturer) and/or different shipping mode.

Another option is to expressly reject the request. By clicking on this link, the seller may be forwarded to a web page at which the seller can indicated the reasons for the rejection. The reasons for rejection may be selected from a fixed list of reasons (e.g., “Item not in inventory,” “Cannot meet terms of request,” or “Price too low”), or the seller may be able to enter, via typed entry, a specific reason for the rejection.

The offers/counters from the sellers may include a deadline by which the offer/counter must be accepted and/or by which the purchase transaction must be concluded. Where multiple offers/counters are provided from multiple sellers responsive to a potential buyer, the potential buyer may accept the one which the potential buyer considers to be the best. If none of the seller offers/counters are acceptable to the potential buyer, the potential buyer can respond with a further request(s) of its own. The process of requests/offers/counters can continue until the potential buyer decides to conclude the transaction (i.e., by accepting the best offer/counter provided) and/or gives up.

The host system may provide the registered seller with the opportunity to set up a seller-specific web page(s) which is unique to the particular seller. The seller-specific web page(s) may enable the seller to promote its products/services, and may include lists/advertisements of products/services offered by the seller, details of those products (price, etc.), ratings of the seller (e.g., reliability, satisfaction of buyers with the seller, etc.), and other seller-specific information. The seller-specific web page(s) may also provide the potential buyer with the opportunity to customize the product(s) to be purchased. The seller-specific page may also include link(s) which enable a potential buyer to conclude purchases from the seller, such as via credit card or PayPal or similar payment systems.

The host system may also provide the option for a seller to register as a preferred seller. Registering as a preferred seller may provide a seller with benefits, such as abilities to: advertise the seller's products on the web site; offer value-added incentives, such as free shipping, free gift wrap, free/discounted extras, or other perks; receive requests/offers (e.g., via email) from potential buyers for products, and accept such requests/offers and/or respond with counteroffers. The acceptance of a potential buyer's request/offer, and/or any counteroffer from the seller, may include a deadline by which the potential buyer must complete the transaction and/or accept the counteroffer. The seller may select from several secure payment options for receiving payment from the buyer and/or paying the seller's corresponding purchase fee to the system, such as credit card and/or online payment systems such as PayPal.

After a sale has been completed, the host system may send the buyer's contact information (e.g., email, address, and/or phone) to the seller, and/or send the seller's contact information (e.g., customer service email, phone, and/or address) to the buyer, in order for the seller and buyer to most effectively communicate regarding details of the sale. For example, the seller may need the buyer's address in order to ship the product, and/or may wish to contact the buyer directly in order to notify the buyer of potential shipping delays, etc. The buyer may want to contact the seller directly if the product is not received on time, or is received damaged, etc.

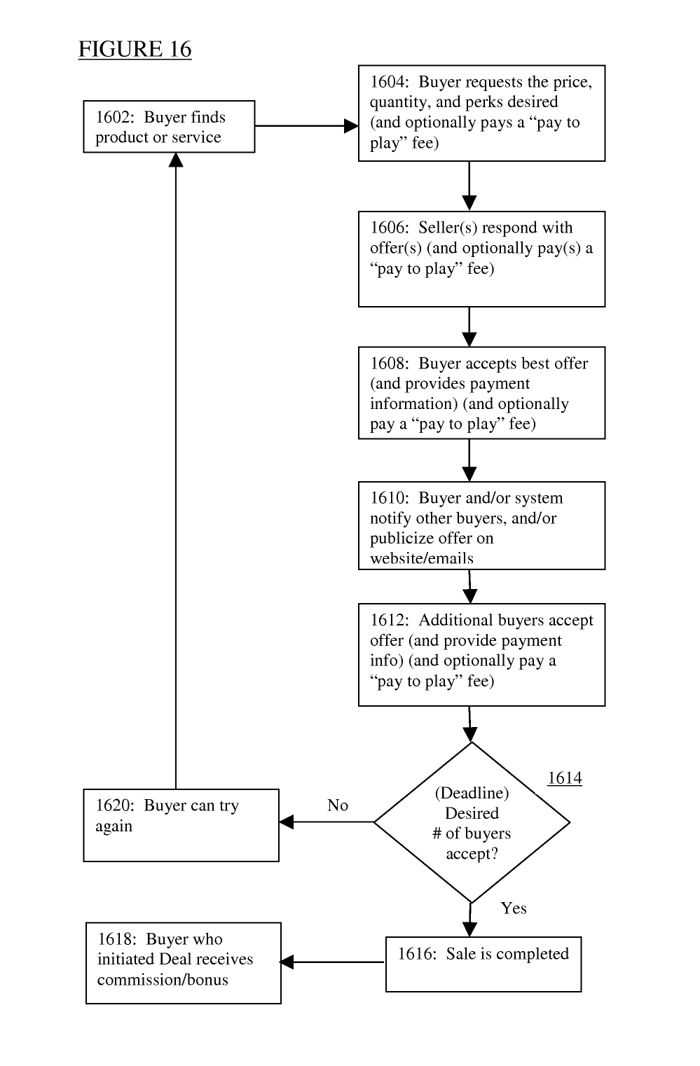

FIG. 16 depicts a flow chart of an embodiment of the invention, which provides buyers the opportunity to combine efforts to obtain reduced prices by purchasing multiple items together. An originating buyer dynamically generates a group deal with such an embodiment. For example, the originating buyer can solicit other potential buyers to join in the initial request, and/or to join in accepting resulting offers from sellers, thus building purchasing coalitions to purchase in volume at corresponding discounts. The invention thus provides buyers with the opportunity to create their own group deals, with sellers competing with each other for the business of a potential group of buyers.

As depicted at box 1602 of FIG. 16, the potential buyer finds the desired product or service. This may involve the potential buyer accessing the host website/system, e.g., from the buyer's computer via the internet as was depicted in FIG. 1. As was depicted in FIGS. 1-3, the host system uses its own, and/or 3^{rd} party, product databases to provide the user with product listings/information (including corresponding seller pricing for the product) in a browsing and/or search mode from the host website. If the potential buyer finds a product offered by a seller with desired options and an acceptable price, the potential buyer can click on a link on the website to indicate the buyer's acceptance of the seller's advertised price, product, and features. The buyer may then be linked to a 3^{rd}-party or seller-specific webpage, outside of the host system, to complete the purchase of the product. The host is compensated on a pay-per-click basis.

As depicted at box 1604 of FIG. 16, if the buyer is not satisfied with the product prices and options listed in its initial search, the buyer can submit a request for offers at lower prices and with different option, as was the case in prior embodiments. This embodiment includes the additional option that the potential buyer offers to buy the product at higher numbers/quantities with additional potential buyers, as opposed to a purchase by a single buyer. This permits the potential buyer to enlist additional buyers in completing the particular purchase to achieve quantity discounts. For example, the system may include a link with a title such as “invite others to join me” or similar language. By activating the link, the buyer can be provided with options to input a request for a particular deal in specific (or minimum, or range of) quantities to include additional potential buyers. Once the buyer's request is made for offers of sale of the product at a specific price and in a specific number or minimum number (which may also include other specific perks), the system selects the sellers to receive the request, and forwards the request to those sellers. The buyer may pay a small fee to submit the request for offers. The sellers may pay a small fee to receive offers from potential buyers.

As depicted at box 1606 of FIG. 16, the sellers can then submit offers/counters to be forwarded or otherwise provided to the potential buyer. The offers could be provided to the buyer in real time, with continuous updates provided to the potential buyer. The sellers may pay a small fee to submit such offers/counters. The seller or sellers may offer to meet the potential buyer's requested terms as is, or may submit a counter with changed terms, such as offering the product at a higher price and/or to be sold only in a higher quantity of products. The seller or sellers may also indicate a deadline by which the offer must be accepted or expire. The seller may indicate a first specific (e.g., minimum) number of products that must be sold to qualify for a first discount price, may indicate a second (and higher) specific number of products that must be sold to qualify for a second (and lower) discount price, may indicate a third (and still higher) specific number of products that must be sold to qualify for a third (and still lower) discount price, etc. In other words, each increase in the level of number of products may qualify the purchasers for a lower price per product. The seller may also indicate a maximum number of products/services for the offer, such as where the seller has limited inventory.

The seller could reduce costs (such as shipping costs) and/or prices by offering the products/services at a discount or with free shipping with the condition that all buyers must pick up or receive the goods/services at a specific point or area. For example, a cleaning service could offer its services at a specific price, with the price only available to potential buyers who agree to have the service provided within a specific geographic area. A seller of product could offer the product at a specific price available only to potential buyers who agree to pick up the product at a specific location/address. A seller of product could offer the product at a discount price and/or with free shipping, with the offer only available to potential buyers who agree to receive the product delivery within a specific geographic area. A seller could also make an offer with various limitations, such as an offer which precludes refunds or exchanges by buyers. Note that the system could require the seller or sellers to offer deep discounts and/or free shipping and/or other perks as a requirement to participate in the program.

Once offers from the seller or sellers are received, the buyer can then review the offer or offers. As depicted at box 1608 of FIG. 16, if the buyer finds an offer/counter to be acceptable, the buyer can click to accept it on a contingency basis, with the contingency being that the buyer can find additional buyers to join in the purchase to meet the quantity of products set forth in the offer/counter. The buyer may then be forwarded to a contingency purchase webpage of the host system to enter its payment information for potential completion of the purchase. Note that the buyer may, depending on the particular embodiment, enter its purchase information at a later time, e.g., after sufficient other buyers have indicated their acceptance of the offer. Also, if the potential buyer does not find any offer to be acceptable, it may either take no further action or may submit a new request (essentially returning to the first part of the operation depicted at box 1602 of FIG. 16).

As depicted in box 1610, once the originating potential buyer has made its contingency acceptance of a seller's offer, other potential buyers can be notified, which may include notification from the originating potential buyer and/or by the system. For example, the system may publish the terms of the seller's offer on web pages and/or via emails or other communications to potential buyers, so that additional potential buyers can review the offer and decide whether to accept it.

As depicted in box 1612 of FIG. 16, the additional buyers can indicate their acceptances of the offer. The acceptances of any additional buyers may be on a contingency basis, as was the case for the originating buyer. Each additional buyer may then be forwarded to a contingency purchase webpage of the host system to enter its payment information for potential completion of the purchase. Note that the additional buyer may, depending on the particular embodiment, enter its purchase information at a later time, e.g., after sufficient other buyers have indicated their acceptance of the offer. Note that if the seller had indicated a maximum number of products/services available with the offer, the system and/or originating buyer may proceed to conclude the sale when that maximum number is reached, even if any applicable time deadline has not yet passed. In other words, once the minimum number of buyers has accepted, the seller is obligated to sell the product. However, the offer can remain open until the maximum number is reached or any applicable deadline passes. The system can keep track in real time of the buyers who have accepted the offer. As additional buyers accept, additional discounts may apply (for example, where a seller offered to sell at a first price when a first threshold number of sales was reached, with a lower second price applying once a second threshold number of product sales had occurred). This real time generation of discounts may be provided to potential buyers via updates of the current price of the goods/services.

In a further embodiment of the invention, potential buyers may receive rewards based on how early they accepted the seller's offer. For example, the system may provide the first 10 or so buyers who accept the seller's offer (or all buyers who accept the offer within a specific time period such as the first hour the deal is offered) with discounted/free use of the system, a further reduction in the price of the products/services of the particular deal, etc.

As depicted at box 1614, the system monitors/counts the number of potential buyers who have accepted the offer, and may also monitor the deadline. If sufficient potential buyers have accepted the offer by the deadline, then the system may complete the purchase. In a further embodiment, if sufficient potential buyers have accepted the offer by the deadline, the originating buyer is notified. The originating buyer can then take a final step (i.e., sending a final acceptance authorization) to the system, at which the system may complete the purchase. Note that in an embodiment of the invention, the consummation of the deal can be based on the total monetary value of the deal instead of on the total number of products sold. For example, the seller can offer to sell a product at a particular price (such as $10 each), with the condition being that a minimum total value (e.g., at least $1000) of products are sold in the deal.

In a preferred embodiment of the invention, all potential buyers will have been required to enter their purchase information when they made their contingent acceptance (e.g., at boxes 1608 and 1610) of the seller's offer. The system can thus automatically complete the purchases once (and if) sufficient potential buyers have accepted the offer, as depicted at box 1616 of FIG. 16. In another embodiment of the invention, the potential buyers will not have to enter their purchase information (e.g., credit card information, etc.) until sufficient buyers have accepted the offer. In such an embodiment, the system can inform all buyers that sufficient buyers have accepted the offer, and give the buyers the opportunity to enter their purchase information to complete the sale. When the purchase is completed, the host system may receive payment (or credit for payment) of a sales commission based on a percentage of the purchase price. The commission may be collected from the seller via a credit card on file for the specific seller in a host system database. As depicted at box 1618 of FIG. 16, around the time that the sale is completed (e.g., when enough buyers have accepted, with the completion of the sale, or afterwards) the originating buyer may receive referral fee (aka origination fee), which may be a reward in the form of a commission, bonus, etc. For example, the originating buyer may receive the product/service which was the subject of the sale at an even lower price and/or for free. The system may also provide rewards for potential buyers who recruit other buyers to the deal. For example, potential buyers (including the originating buyer) may have the ability to forward a “link” to friends/associates/others, with the link (when activated) taking the friend/associate/other to a website of the system which provides the friend/associate/other with the chance to join the pending deal. A potential buyer may receive a reward (commission, discount, etc.) when a friend/associate/other activates the link provided by the potential buyer. A potential buyer may (alternatively or additionally) receive a reward when the sale is completed, with the reward based on the number of persons who joined the deal via links forwarded by that particular potential buyer. Such rewards may include money, free products/services, discounts, etc.

If insufficient buyers accept the offer (by the deadline, if applicable), the buyer can try again, as depicted at box 1620 of FIG. 16. The buyer can then return to search for products/prices, as depicted at box 1602, and/or proceed to submit a further request for offers for the same and/or different products, as depicted at box 1604.

Embodiments of the invention such as that depicted in and described with respect to FIG. 16 can have various applications for various goods and services. For example, an originating buyer could request bids from insurance companies to provide insurance such as health care, dental care, car insurance, property insurance, etc. at rates normally reserved for somewhat large groups. One or more insurance companies could make offers to provide insurance policies at reduced rates provided that a minimum number of people join a “group” (originated by the Originating Buyer) to receive such insurance. A condition of the individuals receiving continued discounts with each renewal period (e.g., with annual renewals, etc.) might be that the “group” must always have a minimum number of sellers therein. If the “group” of sellers in a particular renewal time falls below a set amount, the discount may be lost or reduced. On the other hand, if the “group” of sellers increases in size, a larger/additional discount and/or additional perks may apply.

In another variation of the group purchase aspect of the invention, the system may provide the seller a chance to modify the offer if insufficient potential buyers indicate their acceptance of the initial group deal. For example, if an offer reaches a decision point/deadline (such as the one indicated at box 1614 of FIG. 16) and there are not enough accepted potential buyers to close the deal, the system may notify the seller of the shortfall in buyers, and provide the seller with the exact number of buyers who accepted the offer. The system may then provide the seller the opportunity to close the deal even without the desired number of buyers, in which case the system will complete the deal upon the seller's acceptance of the lower number of buyers. The system may (also or alternatively) provide the seller with the opportunity to propose a modification to the original offer (e.g., a different price, different goods, different perks, different minimum/maximum number of buyers, etc.). The proposed modification can then be sent to the buyers who had already indicated their acceptance of the original (or prior) contingency offer, and each of those potential buyers may be given a period of time in which to indicate their acceptance of the proposed modification. If sufficient potential buyers indicate their acceptance, then the sale will be concluded, such as in the manner indicated at box 1616, etc., in FIG. 16.

If the maximum number of accepting buyers is reached, the system may provide the option for the “extra” buyers (i.e., those who were excluded from the original deal because the maximum number had already been reached) to communicate with the seller for another potential deal on the same or similar products. The system may also provide one or more (e.g., all) of the “extra” buyers with the opportunity to solicit offers, individually and/or as a group, from sellers to serve the needs of that group. The system may also include the option for the originating buyer (from the original deal which was concluded but had to exclude the “extra” buyers) to receive a reward (e.g., commission, bonus, etc.) based on the conclusion of any group sale resulting from the communication between the “extra” buyers and the seller.

Revenue generation may be provided by charging so-called “pay to play” fees to the originating buyer, other potential buyers who accept on a contingency basis, and/or sellers. For example, the originating buyer may be charged a fee for submitting the initial request for offers, and/or for accepting the “best” offer for forwarding to other potential buyers. Sellers may be charged for submitting offers. Other potential buyers may be charged for indicating their contingent acceptance of the offers. Various combinations of such fees, and with various perks, are also in the scope of the invention. The “pay to play” fees of the originating buyer, the seller, and/or the other potential buyers may be reduced and/or refunded in total if a sale is actually completed based on the request and/or offer and/or contingent acceptance for which the fee was paid.

In this application, various perks have been addressed. Such perks may include free shipping and handling, overnight shipping, free return shipping, money back guarantee, seller pays tax, free gift wrapping, free extended warranty, other free extras (to be specified by seller), demo model, used or refurbished model, assembled, and/or store pickup. Note that this list is not all inclusive, and other perks are also within the scope of the invention.

Although the systems and methods of the invention have been described herein according to exemplary embodiments, the described implementations of the invention are susceptible to various modifications and alternative constructions. It should be understood, that there is no intention to limit the invention to the specific form or forms disclosed, but on the contrary, the intention is to cover all modifications, alternative constructions, and equivalents falling within the spirit and scope of the invention.

1. A method for advertising, selling, and purchasing products in an online environment, comprising:
presenting a potential buyer with at least one specific product available for immediate purchase at a pre-set price and with set options, wherein the;
providing the potential buyer with the option to request sellers to offer the specific product with different options and at a lower price from the pre-set price;
identifying one or more potentially relevant sellers responsive to a request from potential buyer to offer the specific product with different options and/or at a lower price, wherein identifying the potentially relevant users comprises is performed by a host-side system via a host seller database;
communicating to the potentially relevant sellers details of the request from the potential buyer, including the lower price or different options, wherein communicating details of the request is performed automatically by the host-side system via an electronic communications server
providing the potentially relevant sellers with the opportunity to provide seller offers to the potential buyer, wherein the potentially relevant sellers are provided with the opportunity to offer any one or more of the following seller offers: offer the specific product to the potential buyer at the requested price and with the requested option; offer the specific product to the potential buyer at a different price; and offer the specific product to the potential buyer with different options;
receiving seller offers from the potentially relevant sellers, wherein receiving seller offers is performed by the host-side system via an electronic communications server;
providing seller offers to the potential buyer;
providing the potential buyer with the ability to review the seller offers; and
providing the potential buyer with the ability to accept or reject the seller offers.

2. A system for enabling advertising, selling, and purchasing of products in an online environment, comprising:
a host-side system comprising a product database, a seller database, and an electronic communications server, wherein the host-side system is configured to:
provide to a potential buyer via an internet connection a search page where the buyer can input product search terms;
provide to the potential buyer via the internet connection, responsive to input search terms input by the potential buyer, at least one specific product available for immediate purchase at a pre-set price and with set options;
provide to the potential buyer via the internet connection the option to request sellers to offer the specific product with different options and at a lower price from the pre-set price;
access the host seller database to identify one or more potentially relevant sellers responsive to a request from potential buyer to offer the specific product with different options and/or at a lower price;
access the electronic communications server to communicate to the potentially relevant sellers details of the request from the potential buyer, including lower price or different options;
provide the potentially relevant sellers with the opportunity to provide seller offers to the potential buyer, wherein the potentially relevant sellers are provided with the opportunity to offer any one or more of the following seller offers: offer the specific product to the potential buyer at the requested price and with the requested option; offer the specific product to the potential buyer at a different price; and offer the specific product to the potential buyer with different options;
use the electronic communications server to receive seller offers from the potentially relevant sellers; and
provide seller offers to the potential buyer;
provide the potential buyer with the ability to review the seller offers; and
provide the potential buyer with the ability to accept or reject the seller offers.

3. (canceled)

4. The method of claim 1, wherein providing the potentially relevant sellers with the opportunity to provide seller offers to the potential buyer comprises providing the potentially relevant sellers with the opportunity to offer to the potential buyer a different but similar product.

5. The method of claim 1, wherein communicating to the potentially relevant sellers details of the request from the potential buyer is performed via an email server, and wherein communicating details of the request is performed via an email server;

6. The method of claim 1, further comprising:
providing the potential buyer with the opportunity to electronically submit one or more enter additional requests responsive to the seller offers, including the opportunity to enter additional requests for the specific product at a different price, for the specific product with different options, and for different but similar products.
